(19) United States
(12) Patent Application Publication
(10) Pub. No.: US 2011/0302558 A1
(43) Pub. Date: Dec. 8, 2011

(54) System and Method for Constructing an Application Using Distributed Functionalities

(76) Inventors: Susan S. Brilliant, Richmond, VA (US); Curt Woodard, Richmond, VA (US)

(21) Appl. No.: 13/146,673

(22) PCT Filed: Feb. 24, 2010
(86) PCT No.: PCT/US2010/025201

§ 371 Date: Aug. 26, 2011

Related U.S. Application Data
(60) Provisional application No. 61/154,775, filed on Feb. 24, 2009.

(51) Int. Cl. G06F 9/44

(52) U.S. Cl. 717/120

(57) ABSTRACT

A system and method are disclosed for factoring the functionalities within one or more applications into separate entities, storing them locally and/or distributing them across a network of servers such that code reusable across applications is updatable at one place, the user of an application sees only the interface relevant, to the task at hand, the interface for the user is consistent across applications utilizing the same functionality while at the same time it remains clear to the user which context the user is in, and additional functionalities may be added and subtracted during run time without recompiling the application or reinitialising the application.

### BACKGROUND OF THE INVENTION

1. Field of the Invention

The present invention generally relates to software implemented distribution of functionalities, and in particular to a methodology for assembling on-the-fly and without recompilation or reinitialization those distributed functionalities required for a task.

2. Background Description

Microsoft Office is a very well-known application suite, one that is used around the world to create and publish several different types of documents. It contains a word processor, spreadsheet, e-mail client, database management system, publishing software, and a presentation creator.

Word was the first of the Microsoft products available for the virtual desktop. It became very popular and many, many features were added to it over the years. It has now become much more than the word processor that it was during its youth. Word can now create Excel-like tables. There are figure-drawing capabilities which used to be available only in PowerPoint, the presentation portion of the suite. The database toolbar allows you to insert new forms, make connections, query databases and perform other database-specific tasks. Using other specialized, toolbars you can create an e-mail, create a web page, run Visual Basic for Applications macros, or work with frames. In all there are twenty stock toolbars. If all twenty are displayed, one-fifth of the screen is covered. But that's not all. Users can create their own toolbars; they can take submenus of toolbars and make them toolbars.

Microsoft Excel has twenty toolbars as well. It has toolbars called “Text to speech,” “Web,” and “Word Art.” Microsoft Word has the final two toolbars but not the “Text to Speech” toolbar. There is an option under the Tools menu, of Word called Speech, but there isn't a toolbar with access that function. Additionally, these menu items and toolbars are visible even though the functionality they provide has not been installed on the machine. If a feature is not installed and you attempt to use it, a dialog box pops up that explains the feature needs to be installed. It gives you the option to install the feature and unless you have the installation medium (which isn't possible in many environments) available to you, the installation will fail. Even after a failed installation, the functionality is still presented to you. How then, in an office environment, does the user install this functionality? The amount of time it takes to travel proper channels to have the IS Department install the missing features may very well outweigh the need for the function.

Looking through the office suite, all told, there are sixty-six stock toolbars, spread (unevenly) over five different applications. Much of the functionality is duplicated in each application (lead, save, print, and other common functions). Worse, if you select the “Customize . . . ” option under the View/Toolbars menu you have access to more toolbars and more functionality—ten more toolbars in Word, eleven more for Excel, twenty-five for Access, six more for PowerPoint, and two more for Publisher (which won't let you add them to the view, probably because of the lack of content in the default new “publication”). This is a grand total of one hundred and twenty built-in toolbars, not counting those created by users.

These toolbars, however, do not display all of the functionality that each of these applications provides. Using the custom toolbar creation portion for each application, a user can add a host of features that aren't even in the default toolbar set. Couple this with the menus available in each application and the user has been given an enormous amount of functionality to use . . . and to find. This is still the tip of the iceberg when you consider that more functionality can be contributed by users who design macros or other software that can attach its own toolbars to the interface like Adobe's PDF Maker add-on.

Much of this functionality is probably shared between the programs that make up Microsoft Office through the use of Dynamic Link Library (DLL) files or Component Object Model (COM) objects; even so, it's still a huge amount of functionality for the user to choose from. Much of this functionality isn't available in the other programs without adding a document created by another of the Office suite programs. In other words, for PowerPoint to use the functionality of Excel, PowerPoint must import an Excel spreadsheet.

Add to all of this the different layouts of each of the products, Word with its single-column, multiple-row layout (lines on a piece of paper), Excel with its multiple-column, multiple-row layout, PowerPoint with its free-flow layout, and Publisher with an interface similar to a hybrid of Word's and PowerPoint's. Access has yet another type of user-defined layout based on the number of records and fields per record (for the database design) or its PowerPoint-like free-form layout for displaying input forms and report displays. As briefly mentioned above, Tables from Excel, documents from Word, and slides from PowerPoint are also considered objects which can be pasted into the other applications.

Not only are these items available for pasting into the other types of documents (and yes, Word documents can be pasted into Word documents) but the entire interface from the other application replaces that of the application you're working in. Select that Word document in the Excel table—which isn't attached to a cell in that table, but a free-floating object outside of the flow of the table—and you are considered to be working within Word; the same is true for working with the imported Excel table in Word. However, try as you might, you cannot insert that Word document into the spreadsheet's cell. You can make it look like it's there, but you cannot actually add the document to the cell.

There are other interface inconsistencies as well. When adding a drawing canvas into your Word document, sometimes the canvas will appear where you want it to and other times it mysteriously doesn't. It you try to resize it, sometimes it resizes, other times it resizes in a way you did not intend then snaps to one side of the document. If you add a rectangle, square, circle, or other drawing object and happen to click in a place text hasn't reached yet, you can draw your object there outside of the drawing box. Or, if you happen to have the cursor showing, a drawing box will suddenly appear in the flow of your text. If you draw outside of the drawing box, you can still draw your desired shape. What is the purpose of the drawing box then?

When typing information in PowerPoint text areas, those that are meant for the title text act differently from those that act as the content text. If the title text outgrows the box, it continues onto multiple lines in the selected font size. The box grows only vertically—the side borders remain fixed. The content textbox, however, maintains the selected font size only until the box fill up. After that the text starts to get smaller to accommodate the content within the box. Eventually, the text is at the smallest font size and the text then spills over the bottom of the textbox leaving the left, right, and top boundaries untouched.

As can be seen, there are a lot of interface and communication issues with Microsoft Office. Functionality is spread across the different programs (and others that utilize the COM objects that Office applications provide) but that functionality is accessed in different ways depending upon the application you are currently using. Finding a certain feature is complicated if you don't understand how the menu and toolbar system works, and the interface acts completely differently based on where the cursor is or what is currently selected—that is to say that the interface behaves in a way the user does not expect. Features that are available in more than one of the applications (e.g. the drawing features of PowerPoint and Word) do not act the same in these applications, or even in successive invocations of the same application even if the version is the same. For example, creating a figure using the drawing tools in Word does not provide the same visual appeal as it does in PowerPoint. Saving the document with the figure and opening it in Word on another computer does not necessarily preserve the layout of the figure; as a matter of fact, even opening that figure in the same copy of Word in which the document was created may not preserve the figure's layout,

All of the above applies to Microsoft Office 2003 (and earlier). But now there's a new version: Office 2007. Gone are the menus and the toolbars, Microsoft now debuts the “Ribbon.” This improvement in interface design takes all the functionality that we've seen above (one hundred and twenty toolbars spread across five applications) and puts it all into one, large toolbar. There are different sections to the toolbar that are accessed with tabs or keyboard shortcuts but the fact remains that all the confusing functionality is available all the time to the user. One of the interesting features is that any functionality on the Ribbon is now available through keyboard shortcuts, which wasn't true for the earlier versions of Office applications. But this single feature doesn't make up for the fact that the equivalent of one-sixth of the screen is hidden by a wide, non-movable toolbar. It may be that through editing preferences, configuration files or some other defining structure (such as an XML file), the Ribbon or interface could be changed; the fact remains that the average user won't know how to do so.

There are two interrelated basic problems with large applications in general and the Microsoft Office Suite in particular:
1. Usability: Users have a love/hate relationship with these products. They love the functionality that's available, but hate that they have such a hard time figuring out how to use it.
2. Complexity of the implementation: The implementations of these programs are incredibly complex. As a result, persistent bugs appear. Features interact in complex and mysterious ways so that features often don't act as advertised. Users are frustrated as they find themselves totally unable to make the software do what it is supposed to do.

We chose Microsoft Office as an example because of its familiarity, but these problems are neither unique to it nor to software that provides the same general functionality, nor to software for any large application having a broad range of functionalities. There are literally tens of thousands of software packages that are installed across the world that have all their features built directly into the main application. They've become monolithic compilations of functionality that seem to horde the functionality they provide.

The problems in user interfaces result from the fact that typical software packages give users control over exactly the wrong thing. Users are given a lot of control over the user interface. Much to their dismay, they mostly have control over the appearance and disappearance of various toolbars, although sometimes these appear and disappear on their own for mysterious reasons. An accidental click of the mouse or key combination may cause an important interface element to disappear, and the user sometimes can't figure out how to get it back.

On the other hand, the control they require to create the content they wish to produce is withheld. Much of the layout and formatting information is hidden.

The complexity of the implementation arises from one fundamental issue there still plagues application development today: most applications contain their functionality within one program. There have been changes in the way people think about the construction of a program: functional decomposition, object-oriented programming, aspect-oriented programming and other technologies have improved the structure of these programs, but including all of the functionality in one monolithic program means that the program is unnecessarily complex. Also, the granularity for sharing of functionality between programs is too small. For example, there are many classes that contribute to the figure-drawing capabilities of Microsoft Word and PowerPoint. The discovery of a bug in one of these classes requires that one or both programs be patched to fix the problem. Adding the ability to draw a new type of figure also requires patching both programs.

### SUMMARY OF THE INVENTION

The Functionally Distributed Application Framework (FDAF) is a method and system by which a set of modular components, referred to as functional components, communicates in such a way as to form a single application. This modularized application consists of a core component which provides access to the user-interactive portion of the application, a set of one or more components which provide additional functionality, and a means to communicate among the components, where the core component may be located on a local computer or remote server and each of the added functional components may be located on a local computer or remote server.

It is therefore an object of the present invention to provide an architecture for distributing functionalities across a suite of application programs such that code reusable across applications is updatable at one place.

Another object of the invention is to provide an architecture for distributing functionalities for an application or across a suite of application programs such that the user of one of the application programs sees only the interface relevant to the task at hand.

It is also an object of the invention to provide an architecture for distributing functionalities across a suite of application programs such that the interface for the user is consistent across applications for the same functionality but at the same time preserves clarity as to which application the user is in.

A further object of the invention is to provide an architecture for an application or software suite such that additional functionalities may be added and made available for use by all included programs without modifying any existing program.

The novelty of the technology responsive to the foregoing deficiencies of the prior art and objects of the invention lies in the way in which the components communicate and cooperate. Currently components communicate in two related ways. One is to use an operating system communication feature such as the Windows Clipboard which allows an object to be copied from one application and pasted into another. When the two applications are part of the same suite, typically there are special pasting options that allow the pasted clipping to be updated when the file containing the object is updated.

To continue with the Microsoft example, the products in the Microsoft Office Suite also allow the user to open a window info another application from a hard-coded list of possible applications using the Insert/Object feature. This second way for components to communicate opens a window for the other application, and the menu structure changes so that it looks like the other application. The window can new be edited, and upon exit, resized. The user interface for this feature is extremely confusing, in that it is difficult to tell which application you are using.

Advantages of the above summarized technology implemented by the invention include:

Implementation Advantages
Elimination of redundancy of functionality within applications. For example, in the Microsoft Office suite, figure-drawing functionality is implemented in both Word and PowerPoint. It is possible to reuse code using conventional methods, but an improvement in the functionality would require updates to both Word and PowerPoint. Using the proposed technology, distributed functional entities can be updated or replaced independently.
Addition of entirely new functionality without modifying the current software. All that is needed is to add another functional component to the application or suite. If the interface for components is made public, third party vendors can provide additional, new, updated, or alternative functionality.

Platform independence. The proposed technology does not rely on the Windows Clipboard or any other platform-dependent feature. The prototype is being developed using JavaScript, XHTML, PHP, and other web standards that allow it to run in a platform-independent web browser.

User Interface Advantages
While creating a visual component, the user is actually working in a small special-purpose semi-independent application. He sees only the interface relevant to the task at hand. There is no need for the user to manage a large number of menus or toolbars and to be distracted or confused by user interface elements that relate to unneeded features.
The user sees a consistent interface for a particular task. For example, creating a picture to insert into a document or presentation is done in exactly the same way. There is no need to cope with slightly different interfaces, as current users of Microsoft Word and PowerPoint must do.
The user does not have to manage all of the data files associated with the current project (and possibly created in an entirely different application) within an FDAF application. The FDAF application's components can provide a means for the application to co-locate said files, allowing for easier backups and providing the user with a sense of control over the data.

An aspect, of the invention is a method and system by which one or more functional components may combine via local or remote communication methods to act as a single application. In another aspect the invention provides an interface to functional components consisting of a set of events which can be accessed through an “event stack” in which all components communicate through local or remote channels, independent of the network protocol, CPU, operating system, or computing device hosting the application or individual functional component.

A further aspect oh the invention is provision of an interface to functional components that allows them to be added to or removed from an application without necessitating recompilation or reinitialisation. It is also an aspect of the invention to provide an interface to functional components that is mutable and able to change without recompilation or reinitialization of any existing component. Yet another aspect of the invention is a communication framework that allows for an application to consist of one or more functional components that reside locally on the same computing device, remotely on a different computing device on a local area network, remotely on an ad hoc network, or remotely on a wide area network such as the Internet.

In another aspect the invention provides a method by which functional components may be chained together to form functional chains or functional nets which may be brought together to form an application via an interface that does not require recompilation or re-initialization upon formation of such chains. A further aspect of the invention provides a framework that can be used to produce applications which are larger than the footprint on the computing device in which they are used. Yet another of the invention's aspects is the ability for functional components to add events of interest to a central repository of events in the main application and the ability to request removal or to remove these events during run time.

It is also an aspect of the invention to provide a clipping technology as a means to view other data which may or may not modify the original sources, where the content of the clipping is controlled by the component or functionality which created it and the container holding the content may be controlled by another or the same component. The invention also has an aspect of having functional components that provide the options necessary for user interaction with interface elements or content within interface elements that the functional component governs.

In a further aspect of the invention metadata is provided to describe the clipping concept as a window or area of interest within some application, image, or other data source for use within another application without modification or destruction of the original application, image, or data source. It is also an aspect of the invention to provide a means to solve the ambiguous selection problem through the use of a user-interactive method which does not require the user to manipulate the position of layered objects in order to modify any of the objects within the layer stack associated with an ambiguous selection.

The technology embodied by the invention could be used to develop or modify software applications or suites of applications to construct an easily expandable architecture that could be either installed on the user's computer or used over the Web as a remote, distributed application.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic showing DLL and plug-in interfaces in a traditional application.

FIG. 2 is a schematic showing a functional component architecture in accordance with the present invention.

FIG. 3 is a schematic showing a general communication model for a functional component architecture application on a standalone computing device.

FIG. 4 is a schematic showing a general communication model for a functional component architecture application spanning a local area network.

FIG. 5 is a schematic showing a general communication model for a functional component architecture application spanning two computing devices across the Internet.

FIG. 6 is a schematic showing a general communication model for a functional component architecture application spanning multiple computing devices acres a the Internet.

FIG. 7 is a schematic showing a general communication model for a functional component architecture application spanning multiple computing devices across the Internet with the inclusion of functional component chaining.

FIG. 8 is a screen display sequence showing the addition of text editing functionality to a core application during run time, after initial program execution.

FIG. 9 is a screen display sequence showing drag and drop of a clipping fed a document.

FIG. 10 is a screen display sequence showing how the invention addresses the ambiguous selection issue.

### DETAILED DESCRIPTION OF A PREFERRED EMBODIMENT OF THE INVENTION

The present invention is a software architecture that provides a new way of “factoring out” the functionalities in a software suite. The concept for this invention originated with discussions of what it would mean to have a “context-sensitive” user interface. As described above, user interfaces for products with complex functionality tend to be very complex, making it difficult for the user to figure out how to access the product's functionality, or even to know what functionality is available. The idea of the context-sensitive user interface is that the interface provides access to only those features relevant to the current user task, and the features needed to change the context—i.e. to signal completion of the current task and/or initiate another task. The task being performed by the user is determined by the context—i.e. by where the user is currently working within an application. “Functional Distribution” was originally conceived as an approach to achieving greater context sensitivity for the user interface, but it has enormous benefits in reducing the complexity of the implementation as well.

Functional Distribution is an alternative approach to implementing applications or application suites (such as an office suite). Applications comprised of a large number of features and functionality may benefit most, but Functional Distribution can be of benefit to smaller applications as well. The current technology for Functional Distribution is exemplified by Microsoft Office. The functionality of the suite is divided among several applications, in particular Word, Excel, PowerPoint and Access. The division of functionality among the programs that comprise the suite is based on the purpose of the product produced. Word creates (primarily text) documents, Excel creates spreadsheets and charts, PowerPoint creates presentations, and Access creates databases. The functionality of these applications overlaps in too many ways, producing unneeded redundancy.

The technology of the present invention factors out common functionalities into a set of separate components that share a communication framework. The communication framework provides them with the ability to communicate with each other at run time.

Functional Components (FCs) included in an office suite using the invention might include:

a word processor

a vector graphics editor

a raster graphics editor

a table/spreadsheet creator

a mathematical equation, formatter

an electronic writing pad (assuming that the platform includes a touch-sensitive screen)

a slide show creator

Instead of several independent applications with, differing interfaces, an FDAF application provides the interface framework (menus, toolbars, etc) that allows the user to interact with the functionality provided by any of the Functional Components (FCs) attached to the FDAF application. As Functional Components (FCs) are attached to the application, the user interactive elements that allow access to their functionality are added to the interface. Functionality that operates behind the scenes (such as compression or encryption features) may also be added. The functionality may also provide a means for the user to work with data directly with a mechanism to define “clippings.” A clipping is, in essence, a window into data. Clippings can be either mutable or immutable, display static or dynamic information, and may come from any number of sources such as spreadsheets, databases, images, text-based files, presentations, etc. that reside in memory or in storage (local or remote).

Once the interface for the FDAF application has been initialized and the functional components governing the current project have been assembled based on a configuration file and/or user selection, the user may begin working within the current context of the application. The user will have options that depend upon the assembled functionality to add new content to the current work area. Suppose, for example, that a functional component providing figure-drawing capabilities added an entry to the “New” menu provided by the application. The user now sees that the work area has been placed into a new context that enables the drawing of figures. This new context may include hew menu items, a new toolbar, and/or other control features relevant to the current task. The user can work in this context to create a drawing, undistracted by the other capabilities of the application.

Now the user wants to include the figure he's been drawing in a text document. He can make the figure available by taking a “clipping.” He selects the area of the figure that's to be included in the text document and creates a clipping that joins an “unused clippings” repository maintained and made available through the layout editor. The user can now choose whether to open an existing document or create a new one. Either way, the user interface will now take on the appearance of a word-processing application that provides only the functionality needed to format text. User interface elements will allow the user to change fonts and sizes, format paragraphs, set tabs, etc. The work space will contain the document. The figure-drawing interface elements have disappeared, and the figure is now immediately available only as a clipping. However, unless the user has closed the figure-drawing editor, it is still available in a layer below the current text formatter.

To insert the figure into the document, the user selects it from the unused clippings repository and selects a location for insertion. In one implementation, the user drags the clipping from an unused clippings area outside the document work space to the place it is to be inserted. The figure can be resized or reshaped as desired. Unless he has closed it, the user can at any time return to the figure drawing layer via an element in the interface provided by the layout editor. He can work on several more figures and take clippings of all of them before returning to the text-editing layer and inserting the clippings in the desired locations. Navigation to the text-editing layer is accomplished via the same user interface element used to return to the figure editor.

The user can also create a figure within the context of the document. To do that, he elects to insert a figure while working in the document. He can then select an area of the screen in which to work. In a preferred implementation, the user obtains an “empty” clipping from the clippings repository, which is then inserted in the desired location and resized as desired. The figure drawing interface will replace the text formatting interface while he works on the figure. When he clicks outside the figure in the text area, the text formatting interface reappears.

To edit any of the figures, whether created within or outside of the document, the user selects the figure for editing. The figure-drawing interface will appear, and the user can begin work. The above-described scenario can occur with any Functional Component and in any order. With just the text and figure editors, the user has the flexibility to insert text boxes in figures, figures in text documents (which are just text boxes with different expansion capabilities), figures in figures, text boxes in text boxes, etc. The clippings can be layered as desired and the user can set the desired opacity, so a text box with a transparent background may be inserted on top of a circle, and the fill color for the circle will show through. Alternatively, the text box may be opaque, so that part of the circle's interior is obscured.

The user can also control text flow around an inserted object. When the object is inserted, by default it might obscure the text in any text box lying below, consistent with what happens when the user places an object on top of any other object. The context menu allows the user to select other flow options. If another flow option is chosen, the user can control how the text box expands.

When the user is finished and saves a project, the layout editor saves all of the components of the project as a group (of project package) under a single user-chosen name. The user can later reopen the project in the layout editor in order to edit it. In one implementation all of the files are saved in a directory; alternatively they could be saved in the operating system's file structure using zip or a conceptually similar format or a database.

The following section describes a proof of concept of a platform-independent technology that will provide the communication framework needed for Functional Distribution.

Functionally Distributed Application Framework Example:

A proof of concept has been programmed, utilizing up-to-date web-based technologies including JavaScript, PHP, and HTML. This allows the application to function in a platform-independent fashion by utilizing the standards-compliant web browser, Firefox. The main application consists of several different functional components which provide the means to take clippings from images, provide rudimentary text editing, and to display the addition of new functionality in real time while the program is running. This also serves as a proof of concept that network-distributed applications are feasible.

In the proof of concept, the user selects the functional capabilities of that particular instance of the application each time the proof of concept is executed. This, however, does not mean that an application written to take advantage of functional distribution has this same limitation. Using configuration files, an application is able to access any pre-defined functionality the user requires for any particular execution of an application. Additionally, when the state of a project is saved the application developer may choose to save a state-based functional listing as well so that a project may be opened with access to the functionality that created it. The proof of concept is by no means a complete representation of the capabilities of the FDAF technology.

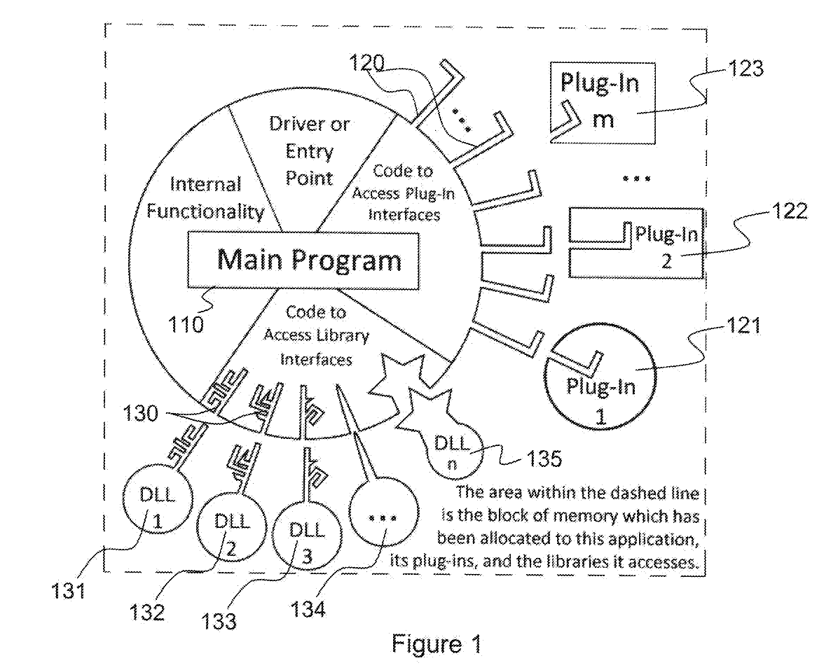

The traditional application 110 depicted in FIG. 1 may have access to a number of different DLLs (131-135) and plug-ins (121-123). The code needed to access the functionality within either of these programming constructs needs to be known at compile time. The programmer of the core application needs to know the interface 130 of the DLLs being used and needs to specify the interface 120 required for plug-ins. In both cases, the interfaces are static. Changes in DLL interfaces 130 require changes to the main application and the affected DLLs 131-135; changes to the plug-in interface 120 within the main application require changes to the plug-ins 121-123 as well. After these changes are made, recompilation is required. DLLs have an additional disadvantage because each DLL has its own, unique interface. Since each DLL has a unique interface, the programmer of the application cannot rely on a single, standard way to access all DLLs. Both DLLs and plug-ins reside in the same memory space as the main application.

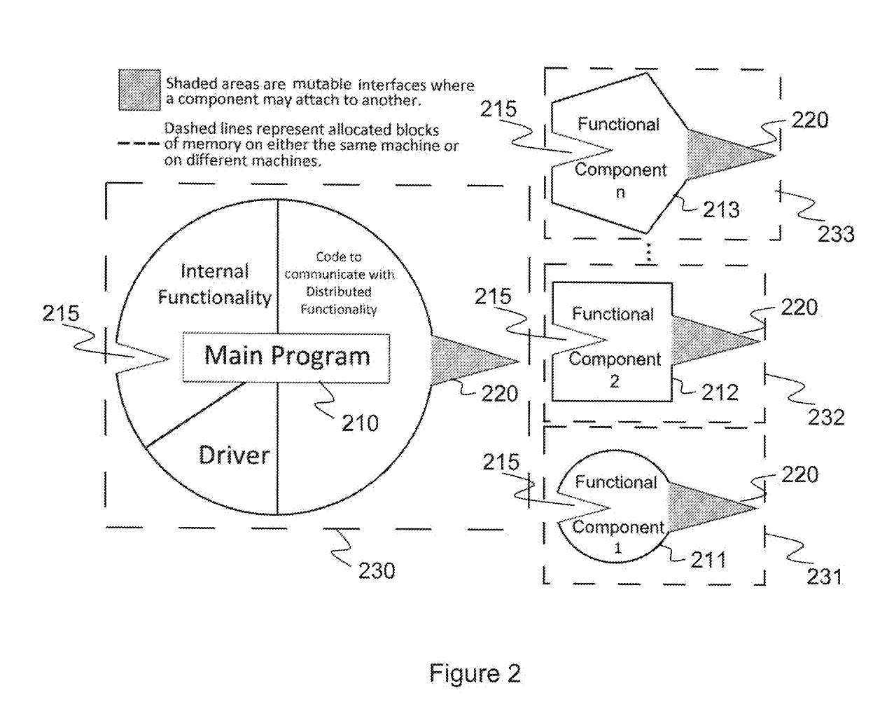

Functional components are similar to DLLs and plug-ins in that they provide functionality to an application. Functional components are more akin to plug-ins in that they are capable of providing arbitrary functionality to an application which was not anticipated when the application was designed. However, functional components differ from both DLLs and plug-ins in important ways. While both DLLs and plug-ins connect to the main application with static interfaces (120, 130), functional components communicate via a mutable list of events. As shown in FIG. 2, the functional components (e.g. 211, 212, 213) can be assembled in a list by using the mutable interfaces 220 to attach to the main program 210 (via connection at mutable interface 215 to mutable interface 220) and to one another. Although communication relies on knowledge of the shared list of events and a semantic understanding of those events, functional components (e.g. 211, 212, 213) may augment the core component's interface by adding or removing events from the event list, allowing the components to communicate with the core component 210 without prior knowledge of the core component 210.

The event list (another type of functional component) is signaled from the functional component by triggering an event to either add needed events or remove events from the list. This makes the interface (215, 220) between the core component 210 and the functional components (e.g. 211, 212, 213) connecting to it mutable and therefore very different from DLLs and plug-ins whose interfaces are static. With the FDAF, all parts of the program are considered to be functional components (i.e. via connections between mutable interfaces 215 and 220, as shown in FIG. 2). Each component has an interface 215 that allows other components to connect to it and can also attach via 220 to another component. There is only one mutable interface, the event list, which shares all the events, within the collected set of components. Additionally, functional components are able to connect to the core component during run time, do not need to be located on the same physical computing device as the core component, and do not need to reside in the same block of memory as the core component, as indicated by distinct memory blocks 230, 231, 232 and 233.

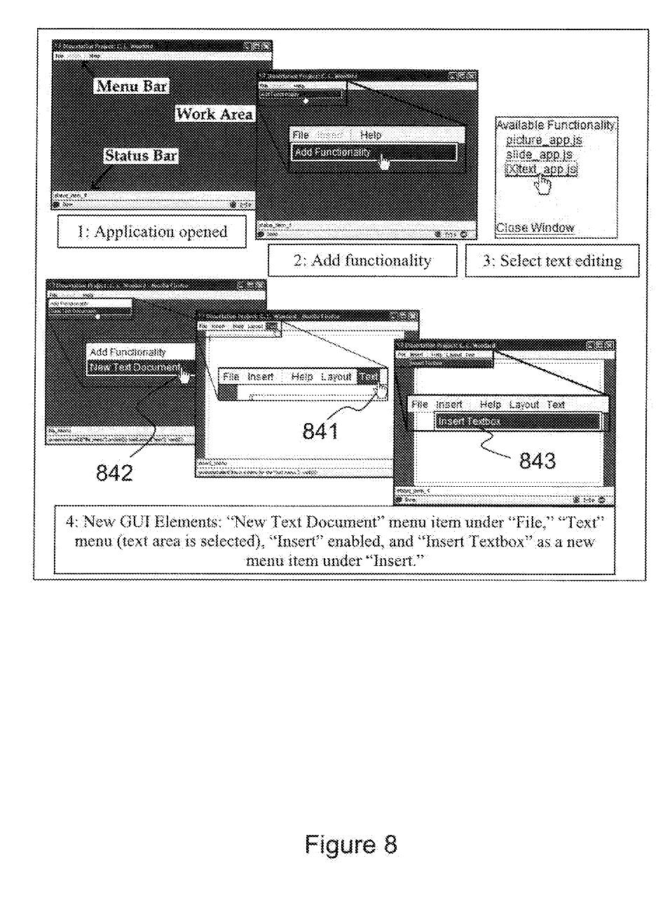

The proof of concept is able to add functionality during run time by attaching to remote functional components. FIG. 8 illustrates the addition of functionality to an application during run time. FIG. 8 3 is a list of functionality that is available to the application and resides on a remote server. Available components can be added and removed on the fly by the server's administrator. FIG. 8 1-3 depict the steps necessary to add text editing functionality, and FIG. 8 4 depicts insertion of a new text box with the text editing functionality that was not previously available.

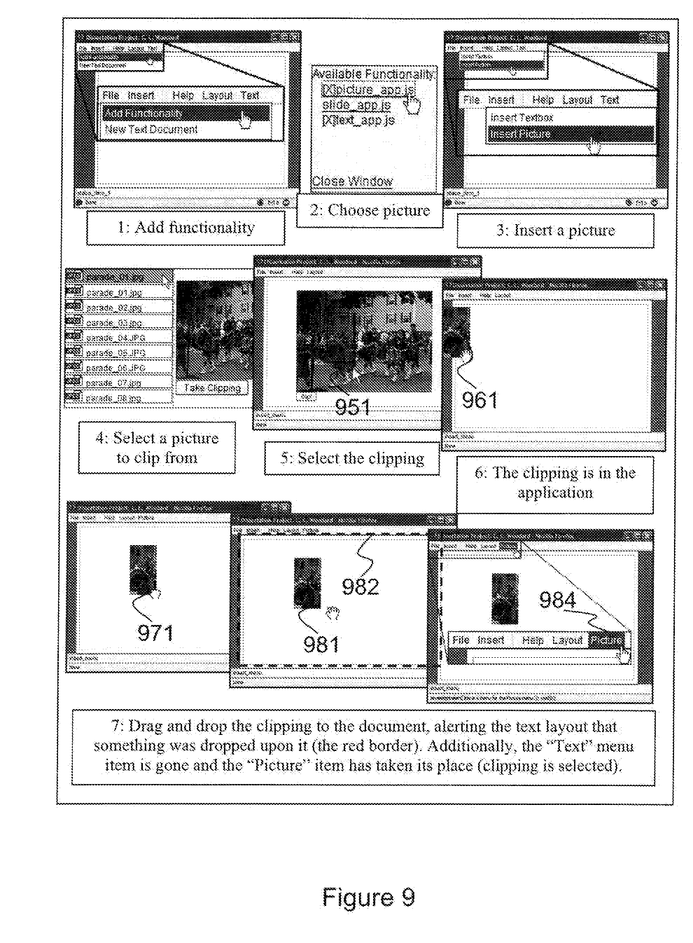

FIG. 9 illustrates the addition of image functionality (FIG. 9 1-2), which allows the user to select clippings (areas of interest) from images available to the current project (FIG. 9 3-6). DLLs and plug-ins do not behave in this way and connect to the main application during program initialization. Adding new DLLs requires that the main application be modified and recompiled. The addition of plug-ins requires that the program be reinitialized.

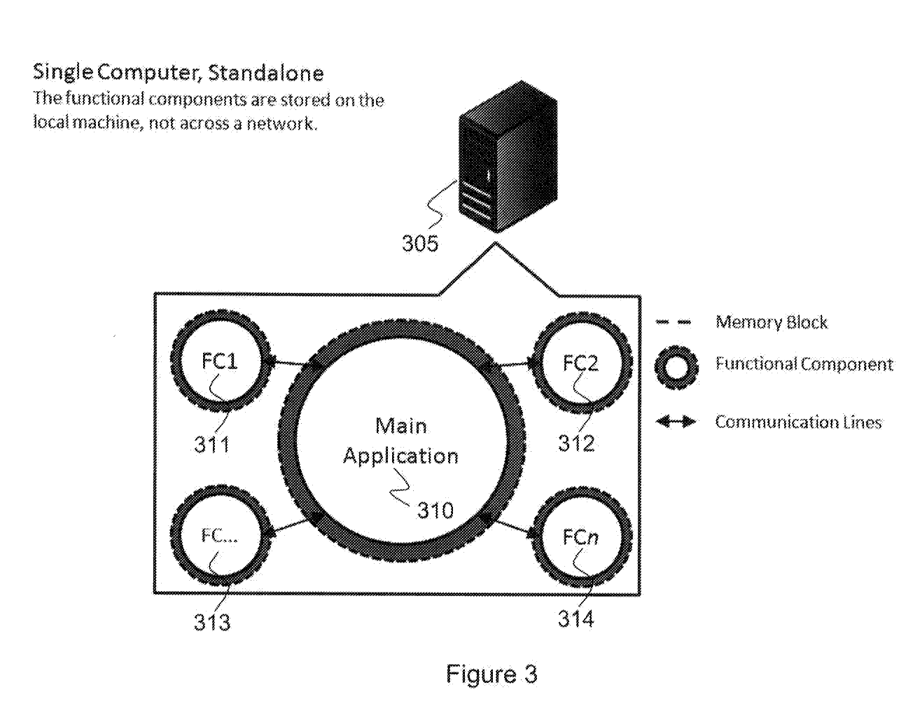

Unlike DLLs and plug-ins, functional components do not have to reside in the same block of memory as the application to which they provide functionality. FIG. 3 represents an FDAF application 310 running on a single computing device 305. The number of processors or cores does not affect how the application runs. The main application 310 may run on a single processor, sharing the single processor's resources with each functional component (e.g. 311, 312, 313, 314), or utilize the full power of a multiple processor/multiple core system by running the main application 310 on one processor/core while the functional components run on others. Each functional component (311, 312, 313, 314) is run in its own block of allocated memory, separate from the main application's core module. If a functional component misbehaves and crashes, the rest of the application is unaffected, provided the crash corrupts only the memory assigned to the failed component.

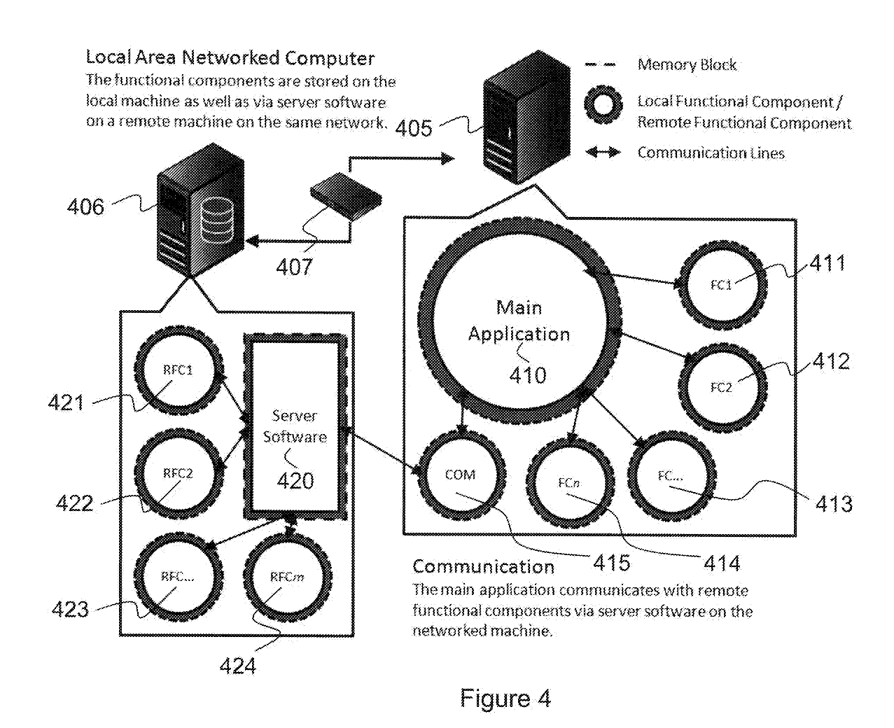

Functional components may also reside on another computing device on a local area network (LAN). FIG. 4 depicts an FDAF application distributed across a local area network (LAN). The “COM” 415 and “Server Software” 420 components represent the means by which the main application 410 communicates with remote functional components (RFCs; 421-424). The server software component 420 for the proof of concept is the Apache HTTPd web server software. Any software which allows a socket connection to receive or send data (such as a MySQL database management system or Microsoft SQL Server for database access or a custom server that supports socket connections in a networked environment) could foe used for this purpose. Through the server 406, remote functional components 421-424 are able to receive requests and events sent from the main application 410, process those requests, and then reply with events and event objects of their own (e.g. with functional components 411-414 on the same server 405 as the main application 410). The remote functional components 421-424 can execute on other computing devices (e.g. 406, connected over local network device 407 to server 405), freeing up the resources of local machine 405 for other tasks and/or creating the potential for larger applications than what the local machine is capable of handling on its own without the aid of the FDAF framework.

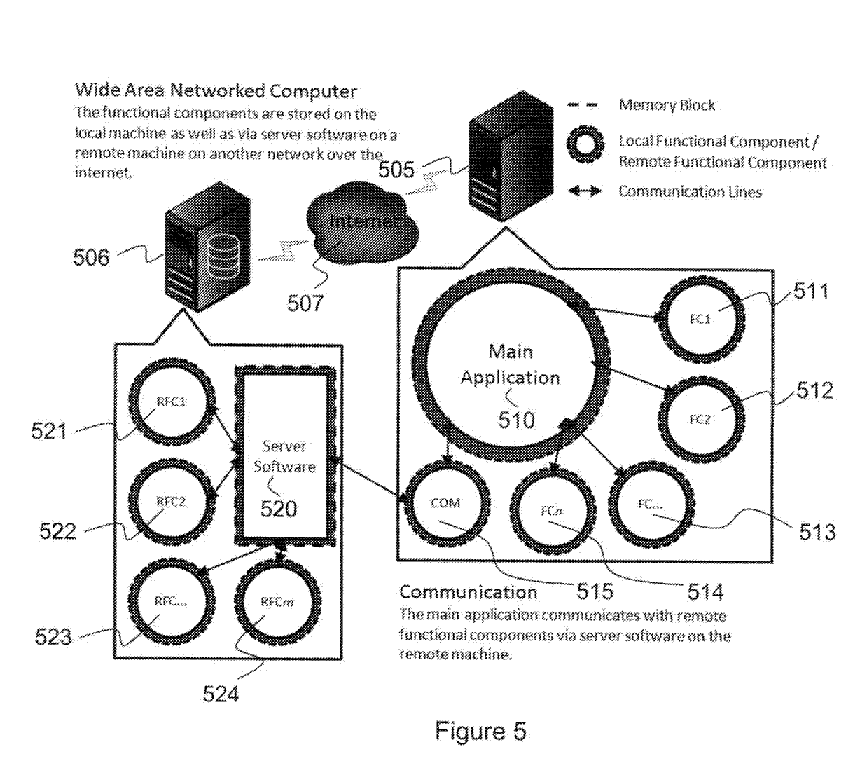

In the same way that the application can be distributed over a LAN, the wide area networked (WAN) environment of the Internet can allow a remote computing device to house functional components (FIG. 5). There are concerns with security in this; however, these issues can be lessened through the use of encrypted connection methods (HTTPS), password-protected access, and other secure means of access. Aside from the larger size of the network, the WAN-based configuration is identical to the LAN-based configuration, with server 505 supporting main application 510 and certain functional components (511-514) with communication 515 through servers (505, 506) over the internet 507 to remote server software 520 and remote functional components 521-524.

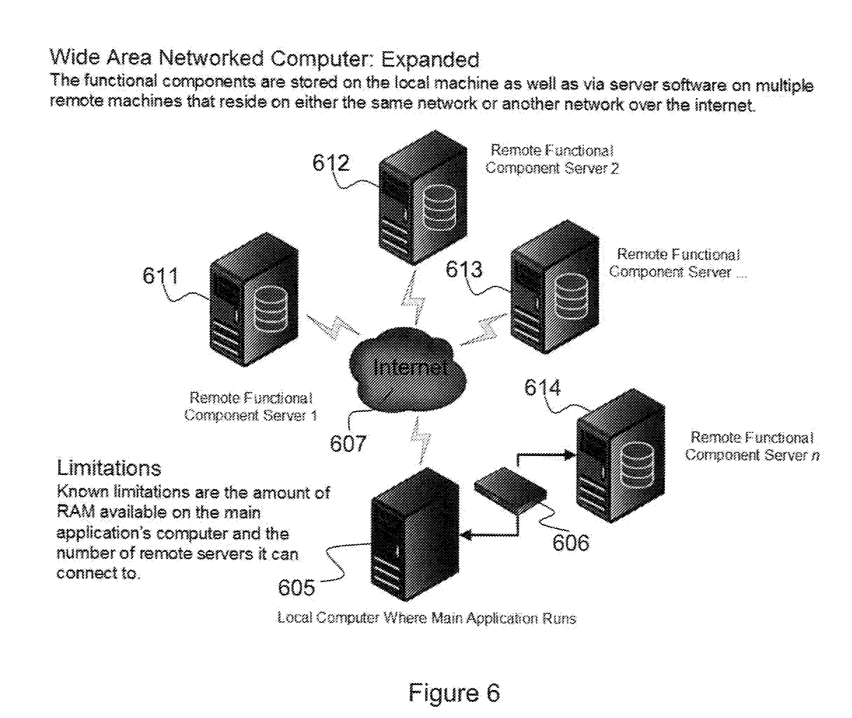

FIG. 6 shows the application distributed across both a LAN (via local area network device 606) and a WAN (via Internet 607) with the main application accessed from the local computer (device 605). Though the figure does not depict additional computing devices connected to the LAN, this is also possible. Each server (e.g. 614) connected to the local machine 605 houses remote functional components (not shown) which the main application (not shown) may access. Through configuration information on the local machine 605, the user can specify any number of remote functional components housed on remote functional servers (e.g. 611-613 via Internet 607 and 614 via LAN device 606) needed for the main application, limited only by the number of connections and the bandwidth needed to connect to the functionality. Since the FDAF does not need to maintain prolonged, continuous connection to functionality the user has specified, the number of remote functional components may actually be larger than the number of connections allowed. This creates the potential for very large applications.

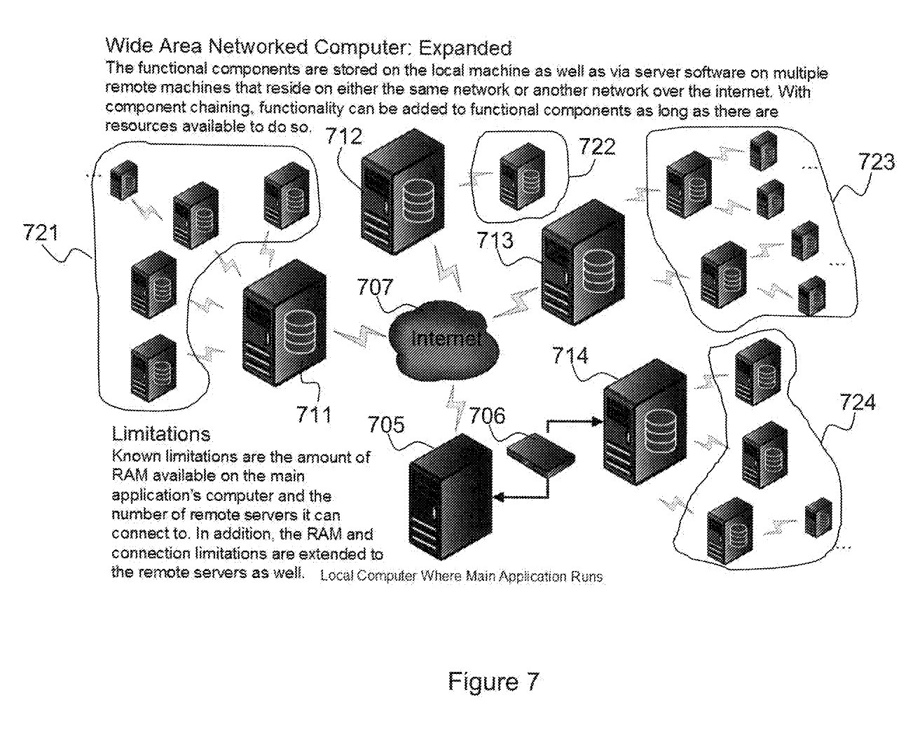

Functional components are not limited to connecting to just the core component and may connect to other components as well. Just as the main component of an application is a functional component and functional components connect to it, components may also connect to components other than the main component. Components connected in this fashion are said to belong to a functional chain. FIG. 7 illustrates the concept of functional chaining, which allows for long chains, nets, or webs of connections among functional components. In FIG. 7, the functional chain may be dispersed over LAN device 706 to remote functional sewer 714 and linked servers 724, and over the Internet 707 to remote functional servers 711, 712 and 713, with linked servers 721, 722 and 723, respectively.

The functional chain connects to the core component on local computer 705 and passes all the events required by the functional chain to the core component. Namespaces can be used to allow a functional component to maintain a unique identity within the structure of such a large, complicated application. Additionally, the core component is also considered a functional component and may attach to other components as well, again passing its events along to the event list of the component to which it is connected. In a networked environment this chaining behavior allows for very large applications with small footprints on the client machine relative to traditional applications. It is possible to design applications with functionality that spans the entirety of the Internet. In all instances, functional components provide the necessary data and/or program code required to perform any given task. The task in question is dictated by a triggered event to which the functional component is subscribed.

In each scenario, the location of functional components may be controlled by the user, the application developer, or another third party for whom the proper permissions have been granted. The location is dictated via some type of configuration information which is available to the core component.

Functional components that interact directly with the user need to know which events the core component provides in order to “attach” to the graphical user interface (GUI). To provide functionality in response to user actions, the functional component subscribes to GUI-based events available in the core component's event list. Depending on the events provided, a component might be able to add a new menu or toolbar or add new items to an existing menu, submenu, or toolbar. Also, the component may add one or more buttons, panels, text areas, or other GUI elements to the main application's user interface. These elements provide the user interactivity required to operate the component's functionality.

As previously discussed, FIG. 8 illustrates the run-time addition of text editing functionality to the application. Once the text editing functionality (located in the functional component “text_app.js”) is added, events are triggered by the functional component which registers a new menu item named “Text” 841, a sub-menu item under “File” named “New Text Document” 842, and a sub-menu item under “Insert” named “Insert Textbox” 843. Each of these menu items triggers events to which the text editing functional component is subscribed. For instance, clicking on the “Insert Textbox” 843 element signals an event to which the text editing component responds with an event of its own. The text editing functionality replies with an event object containing dynamically generated program code and/or data which tells the main component what to do for the particular user-generated event. In this case, the event generated by the text editing component signals the main application to create a new box (for drag and drop purposes) which contains a new text area for entering text.

A component may also provide general-purpose GUI functionality. Drag and drop functionality, for example, is available in most modern applications. The proof of concept includes this functionality as well through another functional component that the main application accesses in order to allow the user to move elements around the screen. The drag event is fired when the user left-clicks on a draggable element and then begins to move the mouse without releasing the button. Any component that is subscribed to such an event may respond with an event of its own. (e.g. highlighting an area that the draggable element may be dropped upon). The drop event is fired when the user releases the mouse button; again, any functional component which is subscribed to the event is able to respond. The proof of concept displays successful drop events by turning the borders of affected elements red, although other user feedback signaling artifacts will be evident to those skilled in the art.

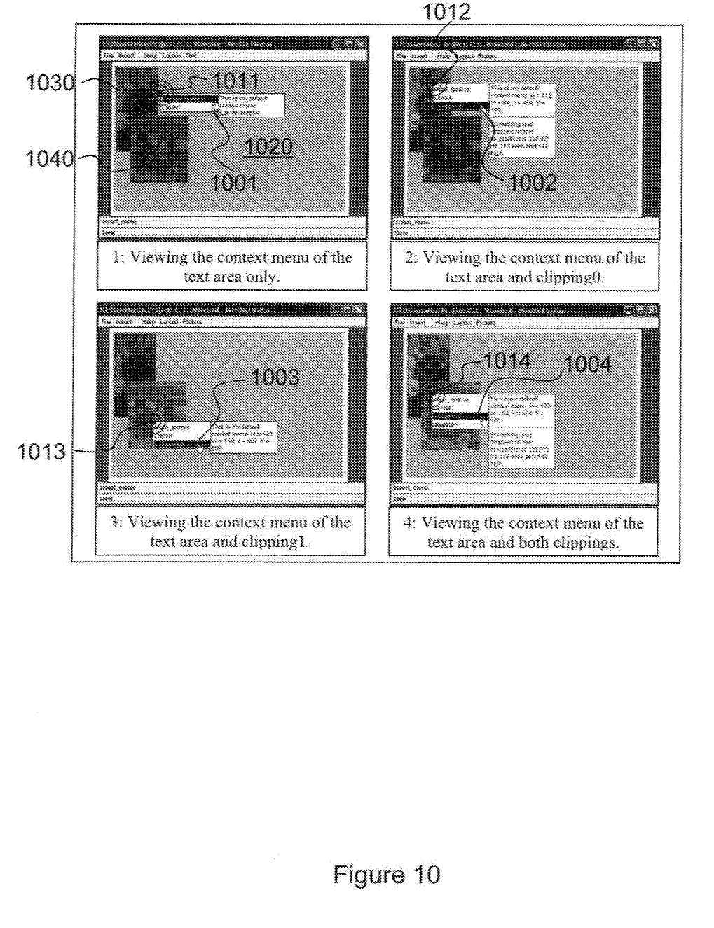

Additionally, the functional component which is responsible for the content that is responding to the drop event provides new context menu information (as described below in connection with FIG. 10), indicating its continuing awareness of the location and size of each element that has been dropped on it. When an element that has been previously dropped on another (base element) is moved and dropped at another location either on or off of the base element, the drop event is fired. Since each element is subscribed to the drop event (to determine if the drop event affects the content within the element), the base element can respond with events of its own which reflect the new state of the application. This may allow the functional component to initiate any number of actions, such as returning text to a non-wrapped state or border colors to their default colors.

Another way in which functional components may interact with each other and with the user is through “clippings.” A clipping provides an imputable “window” into an area of interest within another set of data. The idea of the clipping comes from the traditional layout method for newspapers where clips of articles, photographs, advertisements, and other elements were glued into place on a larger layout sheet. In this same way, the proof of concept allows digital documents to be created by assembling clippings from one or more images and text boxes. A clipping might also originate from a source such as a database, spreadsheet, text document, or other location.

FIG. 9 illustrates the process of taking clippings from an image. First the picture clipping functionality is added to the application during run time (FIG. 9 1-2). Once the appropriate program logic has been added to the application, the user is able to insert a new picture by selecting an image from a list (FIG. 9 3-4). Once an image has been opened, the user selects an area of interest (depicted by the dashed rectangle 951 in FIG. 9 5) and clicks the “Clip!” button. The new clipping 961 is now available for positioning 971 within the main document (FIG. 9 6-7). When the user clicks on the clipping to move it and the clipping has been dropped into position 981, the drop event is fired, sending a message to the text editing functional component (because it is responsible for the current work area, which is a text document) and to the picture clipping functional component. The text editing functional component responds with an event that defines a default action (e.g. change the text area's border to red, as depicted by the dashed rectangle 982) and may provide options for wrapping text around the object, printing text behind the abject, ignoring the object, or other presentation-based actions. The event also updates the context menu of the main text area. The picture clipping functional component replies with an event that creates the “Picture” menu item 984 and enables it for user interaction. Additionally, the “Text” menu item has been hidden due to the change in tasks from editing text to positioning an image. Behind the scenes, this clipping information is also added as a part of the data which is sent to the server when the user elects to save the current project state.

Functional components do not necessarily provide interactive functionality to users at all; some may provide application-level functionality only. The proof of concept has many application-level functional components at its disposal. A JavaScript-based, custom event handler which provides access to new events, an Asynchronous JavaScript and XML (AJAX) communications object for communication with remote components, and a set of wrapper functions for faster programming of new functionality are available and included in the main application by default.

Another example of possible non-GUI functionality (not implemented in the proof of concept) is database access. A possible use of database access would be to save the current state of the application. The user might select a menu option that saves the current project, triggering a save state event. The save state event causes any components which need to save state (and therefore subscribed to the save state event) to reply to the event with the data to be saved. A state-saving component may listen for this reply (which is also an event) and place all the affected data info a database, an archived file (such as a ZIP file), or within the server's file system. The saved project can then be opened at a later date for further examination, modification, publication, or other necessary function. The final location and format of the saved data are determined by the state-saving component, possibly chosen by the user from among several choices. The functional components themselves dictate what data will be saved and in what internal format.

Although this application and communication framework has important benefits, with the increase in communication, bandwidth becomes an issue. The size of a single file may cause slowdowns which may cause the application to respond very slowly to user input, thus appearing to be “broken.” Communication between modules is handled via an object packet that contains encapsulated data and/or program code. With many user interactions and the triggering of many events, this communication method can become bogged down. The effect of this problem can be mitigated by reducing the size of the files being communicated.

In the proof of concept, an approach taken to reduce the amount of data being communicated is to use metadata to describe a clipping. Clippings do not modify the original file and many clippings may be taken from a single file to produce the desired output in the current project. Even if there are multiple clippings taken from the same source, the file itself is downloaded only once. This reduces the overall amount of data communicated from the main application to the server and also preserves the quality of the original image (JPEGs lose quality each time they are saved due to the lossy nature of the JPEG format). The clipping itself describes the coordinates of the user-selected region within the original image as well as its height and width. In the case of a spreadsheet, the metadata could point to the spreadsheet file and the rows/columns of interest within that file. This metadata would require much less bandwidth than the complete contents of the area of interest.

When saving the state of a project, the metadata concept helps to reduce the size of the overall saved file. Since metadata is not concerned with the content of what it represents but the viewable size of said content, the state information for any given project can be reduced to the original files from which the clippings were generated and the metadata describing how the clippings are presented to the user. Images are not replicated several times within the saved state, only once, as are spreadsheets, text, and other data types displayed in the project.

With user-interactive applications the main application may have a work area where the bulk of content creation occurs. This is especially prevalent in document building applications such as word processors but may also be appropriate in any application that allows a user to manipulate content. The proof of concept has a component called a layout, a functional component dedicated to the arranging of content on a particular type of document. The layouts implemented in the proof of concept provide simple text editing and slide creation. It is within this graphical “sandbox” that drag and drop events occur when a user changes the position of a clipping of textbox. The layout is not concerned with the content the user is manipulating; instead, it is the content's container. These containers, or boxes, are what the layout is concerned about moving around the document, not the content. The content is governed by the functional component that created it. In the proof of concept, each functional component is written in PHP which generates dynamic JavaScript code when the functional component responds to an event to which it is subscribed. For instance, after adding picture clipping capabilities (FIG. 9 1-3), then loading a new image for clipping (FIG. 9 4-5), the image information (image location, height, width) is dynamically created by the picture clipping functional component and sent back to the web browser. Images are then presented to the user for clip-taking, at which point metadata is generated to describe the height, width, clipping ID, and image source (the image location). This metadata is passed to the main application for display purposes. The user is then given the option to place the image clipping at any location in the project's work area (FIG. 9 6-7).

Another concept implemented in the proof of concept is content layering. Content layering allows the user to place one or more elements on top of another. Layered work areas have been available in modern image editing software such as Adobe's Photoshop and Microsoft's Office products. In applications like Photoshop, the layers are the same size as the overall work area (the image being edited), and a separate menu is provided to select a layer for editing. Attempting to modify or access the content of one layer while another is selected produces unexpected results. In Microsoft's Office suite, the layered items are instead reduced to the shapes encompassing content (circles, rectangles, triangles, etc). While this aspect, offers an improvement over Photoshop's work area-sized layering system, it gives rise to the ambiguous selection problem. When a user clicks on an item that is part of a layered stack, the user's intent may be ambiguous. Office applications assume that the user is attempting to select the top element in the stack and do not allow the user to access other elements in the stack without moving the top-most items out of the way. This is confusing to the user and frustrating because the elements not only need to be moved out of the way, but also must be returned to their original positions after editing the element on the lower layer.

FIG. 9 7 demonstrates the text layout changing its border color when an image clipping is dropped on it (or within its borders). This is a simple way to show how the functional components interact within the work area. As content is added from various components, events are triggered which allow other components to react to the changing state of the work area. This allows effects such, as text wrapping around an image, border color changes, and image transparency to allow a partial view of image data below to be implemented. In all cases, the components are notified via events that something has happened. Each component replies with an event object that may dictate a default action to be executed (e.g. turning a border red, as indicated by dashed rectangle 982 in FIG. 9 7) and/or provide updated (or new) options for the content's context menu (as described below in connection with FIG. 10). When elements are moved around the document through drag and drop operations, they may be moved onto or off of other elements. When this happens, any elements that were previously covered or are now covered are notified via events that something has affected their current state. This allows the controlling functional components of the content within the affected elements to respond as described above or in different ways including removal of borders, wrapping of text, or other actions as appropriate.

The proof of concept allows the user to choose the desired element when an ambiguous selection is made. When the user right-clicks on a point within a stack of elements, a list of context menus of all layered elements which encompass the point at which the user clicked is displayed so that the user can choose the desired element. This allows the user to select and modify an element in any layer.

This methodology is shown in FIG. 10. For the purposes of this illustration it will be observed that each panel in FIG. 10 contains the same three layered elements: a text layer 1020 occupying the entire screen area; a clipping0 1030 in the upper left corner; and a clipping1 1040 below and to the right of clipping0 1030. Note that clipping0 1030 and clipping1 1040 overlap each other, and both clippings overlap the text layer 1020. Consequently, it is readily apparent that there are four types of layering that a user may designate by right-click selecting various areas on the screen. These four options are shown in the four screen views shown on FIG. 10.

FIG. 10 depicts the user right-clicking on certain points within a text document which has two clippings on top of it. In FIG. 10 1, the user has elected to right-click at point 1011 in the text area of the main document. The menu 1001 reflects what layer selection options are available for the content in the current context of the task at hand. The layout is always affected, and therefore will appear as a menu option in every view. In addition, a menu item for the text area appears in menu 1001. In FIG. 10 2 the user has selected a point 1012, which is on first clipping (clipping0). However, the text area is beneath the clipping. The context menu 1002 reflects this by including “clipping0,” along with the layout and main text area, on the list of elements whose context menus may be opened.

FIG. 10 3 repeats the process with the second clipping (clipping1) as the target of the right-click at point 1013, with menu 1003 showing the layout, main text area, and “clipping1” as the selected elements. Nate that the opened context menus for clippings and clipping1 are different because the picture clipping functional component was notified by the main application that something bad been placed (or dropped) on top of clipping0. The picture application responded with new context menu items to handle the new context. In FIG. 10 4, the user has right-clicked at point 1014, where the two clippings overlap. This section of clipping1 covers all the visible elements of the document, which therefore appear in menu 1004: the main text area, the layout, clipping0 and clipping1. As can be seen in the view, all the elements which include the point of the mouse click are available in the menu 1004.

The menu items on the context menu are presented in order of creation; this was the most convenient order for the programmer. However, the list may easily be sorted by the order in which the elements were placed in their present positions, either from, the top of the stack to the bottom or vice versa.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A method for organizing a software application, comprising:
factoring the software application into a plurality of functional components, including a core component;
distributing the functional components to one or more servers;
initializing the core component;
adding functionality to the core component by adding functional components from said plurality to a list, said list being operable to attach listed functional components to said core component.

2. A method as in claim 1, further comprising:
removing functionality from the core component by removing a listed functional component from said list.

3. A method as in claim 1, wherein each of said functional components, including the core component, has a mutable interface attachable during run time to any other of said listed functional components.

4. A method as in claim 1, wherein said core competent is located on a local computer and at least one listed functional component is located on a remote server.

5. A method as in claim 4, wherein said remote server is connected to said local computer by a local area network.

6. A method as in claim 4, wherein said remote server is connected to said local computer by a wide area network such as the Internet.

7. A method as in claim 1, wherein the functional components on said list are chained together.

8. A method as in claim 1, wherein one of the functional components on said list adds an event to a central repository of events in the core component.

9. A method as in claim 1, wherein one of the functional components on said list enables a clipping functionality for viewing in one application data from another application.

10. A method as in claim 9, wherein one of the functional components on said list is a functionality for displaying to a user a menu of layers in a display layout affected by a user selection.

11. A system for organizing a software application, comprising:
means for factoring the software application into a plurality of functional components, including a core component;
means for distributing the functional components to one or more servers;
means tor initializing the core component;
means for adding functionality to the core component by adding functional components from said plurality to a list, said list being operable to attach listed functional components to said core component.

12. A system as in claim 11, further comprising.
means for removing functionality from the core component by removing a listed functional component from said list.

13. A system as in claim 11, wherein each of said functional components, including the core component, has a mutable interface attachable during run time to any other of said listed functional components.

14. A system as in claim 11, wherein said core component is located on a local computer and at least one listed functional component is located on a remote server.

15. A system as in claim 14, wherein said remote server is connected to said local computer by a local area network.

16. A system as in claim 14, wherein said remote server is connected to said local computer by a wide area network such as the Internet.

17. A system as in claim 11, wherein the functional components on said list are chained together.

18. A system as in claim 11, wherein one of the functional components on said list adds an event to a central repository of events in the core component.

19. A system as in claim 11, wherein one of the functional components on said list enables a clipping functionality for viewing in one application data from another application.

20. A system as in claim 19, wherein one of the functional components on said list is a functionality for displaying to a user a menu of layers in a display layout affected by a user selection.
